(19) United States
(12) Patent Application Publication
(10) Pub. No.: US 2025/0196927 A1
(43) Pub. Date: Jun. 19, 2025

(54) JOINT STRUCTURE OF A VEHICLE BODY

(71) Applicants: HYUNDAI MOTOR COMPANY, Seoul (KR); KIA CORPORATION, Seoul (KR)

(72) Inventors: Yeongjae Kim, Hwaseong-si (KR); Yoonkyoung Han, Hwaseong-si (KR); Joonghyun Shin, Hwaseong-si (KR); Won Ki Song, Hwaseong-si (KR)

(73) Assignees: HYUNDAI MOTOR COMPANY, Seoul (KR); KIA CORPORATION, Seoul (KR)

(21) Appl. No.: 18/922,067

(22) Filed: Oct. 21, 2024

(30) Foreign Application Priority Data
Dec. 15, 2023 (KR) 10-2023-0183029

(51) Int. Cl. B62D 24/00; B62D 21/15; B62D 25/02; B62D 25/04; B62D 25/16

(52) U.S. Cl. CPC B62D 24/00; B62D 21/157; B62D 25/025; B62D 25/04; B62D 25/16

(57) ABSTRACT

A joint structure of a vehicle body constituting a cabin part of a vehicle. The joint structure includes: an underbody forming a lower part of the cabin part; an upper body coupled to an upper part of the underbody; a fixing rail connecting the underbody and the upper body and configured to guide the upper body when the upper body moves relative to the underbody; a fender apron provided at an upper edge portion of the underbody; a side sill provided at a lower end edge portion of the underbody; an actuator provided on the side sill and installed at a lower end of the fixing rail to provide a driving force to move the fixing rail; a side member coupled to a central portion of the underbody; and a fender extension connecting a lower part of the fender apron and an upper part of the side member.

### CROSS-REFERENCE TO RELATED APPLICATION

This application claims priority to and the benefit of Korean Patent Application No. 10-2023-0183029, filed in the Korean Intellectual Property Office on Dec. 15, 2023, the entire contents of which are incorporated herein by reference.

### BACKGROUND

### (a) Field

The present disclosure relates to a joint structure of a vehicle body, and more specifically, to a joint structure of a vehicle body that can support load of an underbody and an upper body constituting a cabin part of a purpose built vehicle (PBV) and absorb and disperse impact.

### (b) Description of the Related Art

Recently, the automobile industry has been introducing a new concept of future mobility, envisioning a dynamic, human-centered city of future. One of these future mobility solutions is a purpose built vehicle (PBV) as a purpose-based mobility.

An example of the PBV may be an electric vehicle (EV)-based environment-friendly mobile vehicle. The PBV may provide a variety of customized services to users while traveling from an origin to a destination in an unmanned or manned autonomous driving manner.

A vehicle body of such a PBV includes a driving part (a drive module to which an in-wheel motor is applied, a rolling chassis, a skateboard (SKB), or the like) and a cabin part assembled to the driving part.

Here, the cabin part may have various shapes depending on types of customized services provided by the PBV. For example, the PBV may be used as a hailing type vehicle with a cabin part located on an upper part of the driving part. In this type of structure, the cabin part may include: an underbody as a fixed part securely attached to the driving part, and an upper body as a variable part coupled to an upper part of the underbody and adjustable in a height direction.

Since the cabin part provides a space for occupants to board, safety should be ensured. To this end, the upper body is necessarily required to be able to move stably on the underbody, and the load of the upper body should be evenly supported.

### SUMMARY

The present disclosure provides a joint structure of a vehicle body that can absorb impact from the outside while stably supporting and coupling an upper body and an underbody of a cabin part of a PBV.

According to an embodiment of the present disclosure, a joint structure of a vehicle body constitutes a cabin part of a vehicle, and the joint structure includes: an underbody forming a lower part of the cabin part; and an upper body coupled to an upper part of the underbody. The joint structure further includes a fixing rail connecting the underbody and the upper body to each other, fixed to the underbody, and configured to guide the upper body when the upper body moves up and down relative to the underbody. The joint structure further includes a fender apron provided at an upper edge portion of the underbody to assist in rigidity of the underbody; and a side sill provided at a lower end edge portion of the underbody and coupled to a driving part. The joint structure further includes: an actuator provided on the side sill and installed at a lower end of the fixing rail and configured to provide a driving force so that the fixing rail moves up and down; a side member coupled to front and rear ends of a central portion of the underbody; and a fender extension connecting a lower part of the fender apron and an upper part of the side member.

In one embodiment, the fixing rail may include a first rail fixed to a body part of the underbody; and a second rail connected to the actuator at a lower end, inserted into the first rail and configured to move up and down within the first rail by the driving force of the actuator.

In one embodiment, the second rail may be inserted into a pillar of the upper body.

According to an embodiment of the present disclosure, the joint structure of a vehicle body may further include a pillar extension connecting the lower part of the fender apron and the fixing rail.

In one embodiment, a lower exterior surface of the fixing rail and an exterior surface of the side sill may be fastened by a bracket.

In one embodiment, the bracket may be coupled to an upper surface of the side sill using at least one fastening pin.

In one embodiment, the actuator may penetrate a central portion of the bracket and be attached to the exterior surface of the side sill.

In another embodiment, the at least one fastening pin may include a plurality of fastening pins, and fastening pins of the plurality of fastening pins may be arranged side by side, two on each of both side portions of the actuator.

In one embodiment, an opening may be formed in the side sill of a vehicle body inner side portion where the fastening pins are located.

In one embodiment, the opening may be covered by an opening cover at the vehicle body inner side portion.

In one embodiment, the fender extension may have a cross-section varying in an upper-lower direction of the vehicle body.

In one embodiment, the fender extension may be configured to be bent or fractured at a portion having a small cross-section when impact is transmitted from the side member.

In another embodiment, a drive module to which an in-wheel motor is applied, a lower chassis (SKB; skateboard), or a rolling chassis may be further provided at a lower part of the underbody.

In one embodiment, the lower chassis may be fastened to the lower end of the fixing rail and a lower end of the side sill.

In one embodiment, the lower chassis may extend toward a lower part side of the side member and may be spaced apart from the side member.

In one embodiment, an extended portion of the lower chassis may be bent toward the lower part side of the side member.

According to the joint structure of a vehicle body according to an embodiment of the present disclosure, it is possible to guide a path along which the upper body of the cabin part of the PBV can move up and down with respect to the upper part of the underbody. In other words, It is possible to guide the movement of the upper body of the cabin part of the PBV up and down relative to the upper part of the underbody. In addition, the upper body can disperse the load applied to the underbody to realize a stable vehicle body fastening structure, maintain vehicle body rigidity, and improve durability.

In addition, when impact from the outside is applied to the cabin part, since the fender member whose deformation is induced is adopted and a space is formed, the impact energy can be dispersed and absorbed, thereby improving safety during driving of a vehicle.

### BRIEF DESCRIPTION OF THE DRAWINGS

FIG. 1 is a view schematically illustrating a joint structure of a vehicle body for a vehicle according to an embodiment of the present disclosure.

FIG. 2 is a view schematically illustrating a load support path in the joint structure of a vehicle body for a vehicle according to the embodiment of the present disclosure.

FIG. 3 is an enlarged view of an ‘A’ portion in FIG. 2.

FIG. 4 is a rear view of FIG. 3.

FIG. 5 is a bottom view of FIG. 3.

FIG. 6 is a view schematically showing an impact absorption and dispersion path in the joint structure of a vehicle body for a vehicle according to an embodiment of the present disclosure.

FIG. 7 is a view showing a lower chassis added to the joint structure of a vehicle body for a vehicle according to an embodiment of the present disclosure.

FIG. 8 is a view showing a deformation section and a rigid body section in the joint structure of a vehicle body for a vehicle according to the embodiment of the present disclosure.

### DETAILED DESCRIPTION

In the following detailed description, only certain embodiments of the present disclosure have been shown and described, simply by way of illustration. The present disclosure can be variously implemented and is not limited to the following embodiments.

Further, in various embodiments, since like reference numerals designate like elements having the same configuration, a first embodiment is representatively described, and in other embodiments, only configurations different from the first embodiment are described.

It should be noted that the drawings are schematic and not drawn to scale. The relative dimensions and ratios of the parts in the drawings are shown exaggerated or reduced in size for clarity and convenience in the drawings, and any dimension is merely exemplary and not limiting. In addition, the same reference numerals are used to denote similar features in the same structures, elements, or parts shown in two or more drawings. When a part is referred to as being “above” or “on” another part, it may be directly above or on the other part or an intervening part may also be present.

Although some embodiment of the present disclosure are disclosed, various modifications of the embodiments should be expected. Therefore, the present disclosure is not limited to a specific aspect of the embodiments and drawings, and also includes modifications of an aspect by manufacturing.

Hereinafter, a joint structure of a vehicle body according to an embodiment of the present disclosure will be described in detail with reference to the accompanying drawings.

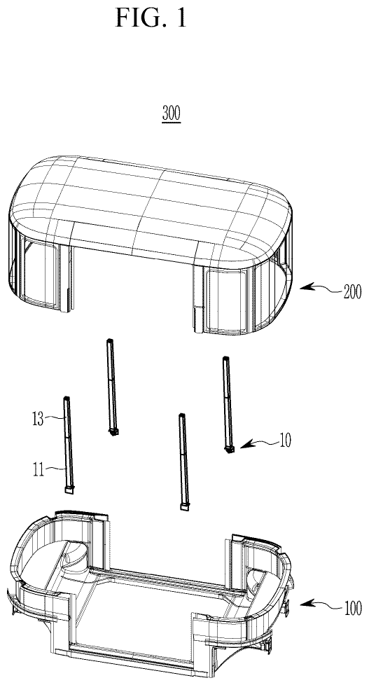

FIG. 1 is a view schematically illustrating a joint structure of a vehicle body for a vehicle according to an embodiment of the present disclosure.

As shown in FIG. 1, the joint structure of a vehicle body for a vehicle according to an embodiment of the present disclosure can be applied, for example, to a purpose-based mobility vehicle (purpose built vehicle: hereinafter, referred to as PBV). In the present disclosure, a joint structure of an underbody and an upper body (100 and 200), which constitute a cabin part coupled to an upper part of a driving part of a vehicle, is exemplified, but the present disclosure is not limited thereto and can be applied to a general joint structure of a vehicle body and can be widely used for a structure for supporting load and absorbing and dispersing impact.

The PBV can be used as an electric vehicle-based life module vehicle that provides various customized services to users while traveling from an origin to a destination.

A vehicle body of such a PBV is suitable for small-scale production of various vehicles with a small number of parts and can be manufactured in various shapes and sizes.

A joint structure of a vehicle body according to an embodiment of the present disclosure is a joint structure of a vehicle body constituting a cabin part of a vehicle. In one embodiment, the cabin part 300 includes: an underbody 100 constituting a lower part, and an upper body 200 coupled to an upper part of the underbody 100.

The cabin part 300 may be provided on an upper part of a driving part of the vehicle. In another embodiment, a driving part including a drive module to which an in-wheel motor is applied, a lower chassis (SKB; skateboard) 80, a rolling chassis, or the like may be optionally provided at a lower part of the underbody 100 of the cabin part 300.

The underbody 100 and the upper body 200 may be connected by at least one fixing rail 10. A lower end of the fixing rail 10 is fixed to the underbody 100 and an upper part side thereof is inserted into a pillar of the upper body 200, so that the underbody 100 and the upper body 200 can be coupled to each other. The fixing rail 10 may guide the movement of the upper body 200 when the upper body 200 moves up and down on top of the underbody 100 and when it is coupled or decoupled.

The fixing rail 10 may include a first rail 11 fixed to a body portion of the underbody 100 corresponding to the pillar of the upper body 200, and a second rail 13 inserted into the first rail 11 and configured to be movable. A lower end of the second rail 13 is connected to an actuator 40 provided to the underbody 100, and the second rail 13 can move up and down within the first rail 11 by a driving force of the actuator 40.

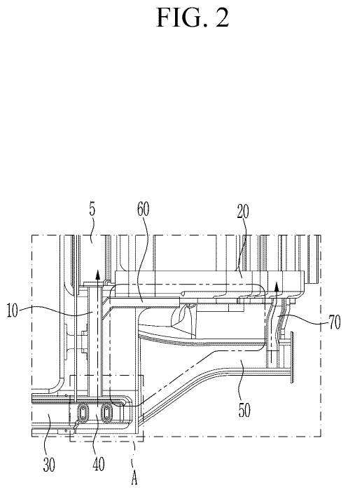

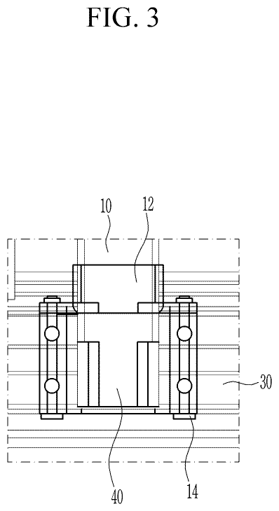

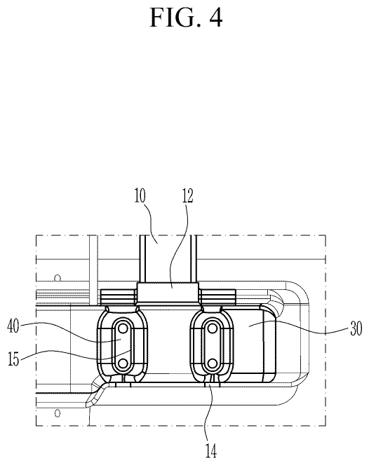

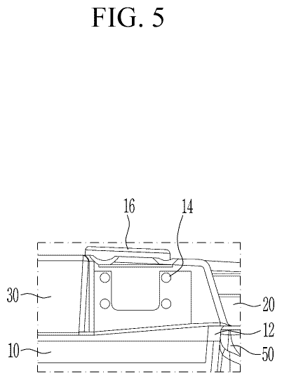

FIG. 2 is a view schematically showing a load support path in the joint structure of a vehicle body for a vehicle according to the embodiment of the present disclosure, FIG. 3 is an enlarged view of an ‘A’ portion in FIG. 2, FIG. 4 is a rear view of FIG. 3, and FIG. 5 is a bottom view of FIG. 3.

Referring to FIG. 2, the joint structure of a vehicle body for a vehicle includes a fender apron 20, a side sill 30, an actuator 40, a side member 50, and a fender extension.

The fender apron 20 is provided at an upper edge portion of the underbody 100 and is a portion where an edge portion of the upper body 200 is seated. A side part of the fender apron 20 may be bent upward so that the upper body 200 is seated on the upper part of the underbody 100 and does not fall off. The fender apron 20 can assist in the rigidity of the underbody 100.

The side sill 30 is provided at a lower end edge portion of the underbody 100 and is coupled to the driving part.

The actuator 40 is provided on the side sill 30 and is connected to the lower end of the fixing rail 10. The actuator 40 may provide a driving force so that the fixing rail 10 moves up and down. The actuator 40 may be a hydraulic cylinder type designed for linear motion.

The side member 50 may be coupled to front and rear ends of a central portion of the underbody 100. The side member 50 may be arranged at a lower part of the fender apron 20 and may protrude outward of the front and rear of the underbody 100. The side member 50 may be provided as a pair arranged on both sides at the front and the rear of the underbody 100. The side member 50 may be provided to have sufficient rigidity to resist impact when the impact is applied to the underbody 100 and the upper body 200 from the outside.

The fender extension 70 connects the lower part of the fender apron 20 and an upper part of the side member 50. The fender extension 70 may be provided as a pair arranged at positions corresponding to the side members 50, (i.e., on both sides at the front and the rear of the underbody 100). The fender extension 70, together with the fixing rail 10, may assist in supporting the load of the upper body 200 by the underbody 100.

The fender extension 70 may have a cross-section varying in an upper-lower direction of the vehicle body. For example, the cross-section of the fender extension 70 may become smaller from the fender apron 20 side toward the side member 50 side. Additionally, the fender extension 70 may be formed such that a cross section of a central portion is small. The fender extension 70 may be bent or fractured at a portion having a small cross-section when external impact is transmitted to the fender extension 70 from the side member 50 side. Accordingly, the external impact is prevented from being entirely transmitted to the cabin part, and the impact can be dispersed.

Referring to FIG. 2, the fixing rail 10 and the fender extension 70 may assist in supporting the load of the upper body 200 coupled to the upper part of the underbody 100. As described above, the fixing rail 10 includes the first rail 11 fixed to the body part of the underbody 100 and the second rail 13 that is inserted into the first rail 11 and moves up and down within the first rail 11. Since the second rail 13 is inserted into the pillar of the upper body 200, the load of the upper body 200 can be partially supported by the second rail 13.

In addition, since the fender extension 70 provided on the upper part of the side member 50 supports the lower part of the fender apron 20, the load of the upper body 200 seated on the fender apron 20 can be partially supported. Therefore, in addition to the load support by the underbody 100, the fixing rail 10 and the fender extension 70 can support and disperse the load of the upper body 200.

In one embodiment, as shown in FIG. 3, a lower exterior surface of the fixing rail 10 and an exterior surface of the side sill 30 may be fastened by a bracket 12. Additionally, the bracket 12 may be coupled to an upper surface of the side sill 30 by a fastening pin 14. The bracket 12 may be coupled in a form of surrounding an upper surface, a side surface, and a lower surface of the side sill 30, and the fastening pin 14 may extend from the upper surface to the lower surface of the side sill 30 to fasten the bracket 12 to the side sill 30.

An upper part of the bracket 12 is bent at both ends toward the inside of the vehicle body, and the fixing rail 10 may be fitted between the bent portions of the upper part of the bracket 12. An upper inner surface of the bracket 12 may be coupled to the exterior surface of the fixing rail 10 by welding.

An opening is formed in a central portion of the bracket 12 so that the actuator 40 can be arranged. The actuator 40 may pass through the opening formed in the central portion of the bracket 12 and be attached to the exterior surface of the side sill 30. The actuator 40 is coupled to the lower end of the second rail 13 of the fixing rail 10, and the actuator 40 provides a driving force to the second rail 13 so that the second rail 13 can move up and down. The second rail 13 is inserted and extended into the first rail 11 and is inserted and supported in the pillar of the upper body 200 to enable the upper body 200 to move up and down.

In another embodiment, a plurality of fastening pins 14 may be provided, and the fastening pins may be arranged side by side, two on each of both side portions of the actuator 40.

As shown in FIG. 4, an opening 15 may be formed in the side sill 30 of a vehicle body inner side portion where the fastening pins 14 are located. As shown in FIG. 5, the opening 15 may be covered by an opening cover 16 at the vehicle body inner side portion.

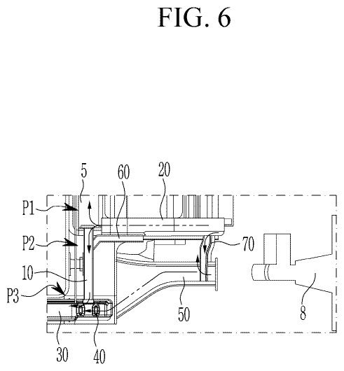

FIG. 6 is a view schematically showing an impact absorption and dispersion path in the joint structure of a vehicle body for a vehicle according to the embodiment of the present disclosure.

Referring to FIG. 6, in a situation where the joint structure of a vehicle body according to an embodiment of the present disclosure collides with an external obstacle 8, the obstacle 8 first comes into contact with the side member 50 of the underbody 100 of the cabin part 300. The impact transmitted to the side member 50 is transmitted to the side sill 30 (P3), and part of the impact is transmitted to the fender apron 20 through the fender extension 70. Part of the impact transmitted to the fender apron 20 is transmitted upward to the upper body 200 through the pillar of the upper body 200 (impact load path “P1”), and part of the impact is transmitted to the side sill 30 of the underbody 100 through the fixing rail 10 (impact load paths: P2 and P3).

In another embodiment, the joint structure of a vehicle body for a vehicle according to the embodiment of the present disclosure may further include a pillar extension 60 connecting the lower part of the fender apron 20 and the fixing rail 10 to absorb the impact transmitted to the side sill 30 through the fender apron 20.

If the fender extension 70 is not included, the impact transmitted from the outside is entirely transmitted to the side sill 30 through the ‘P3’ path, which may cause damage to a component such as a battery provided in the side sill 30 by the strong impact. However, when the fender extension 70 is included, the impact transmitted from the outside is transmitted to the pillar of the upper body 200 and to fixing rail 10 through the fender apron 20, so the impact is dispersed.

In addition, even if excessive impact is transmitted from the outside, when the fender extension 70 with a variable cross-section is applied, a portion with a small cross-section of the fender extension 70 is bent or fractured, thereby absorbing and dissipating the impact.

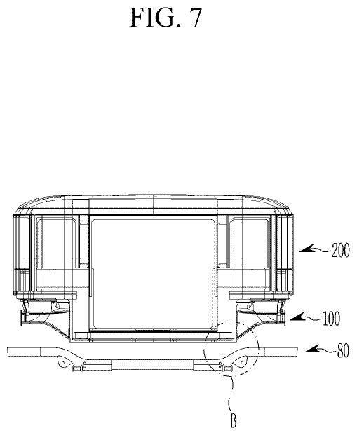

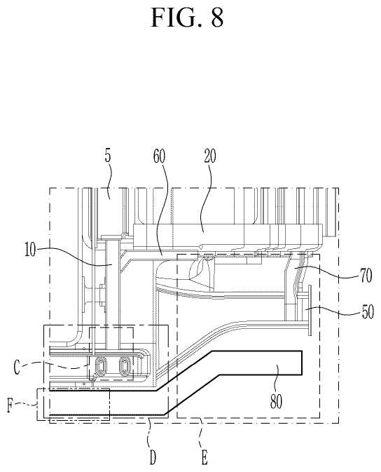

FIG. 7 is a view showing a lower chassis added to the joint structure of a vehicle body for a vehicle according to the embodiment of the present disclosure, and FIG. 8 is a view showing a deformation section and a rigid body section in the joint structure of a vehicle body for a vehicle according to the embodiment of the present disclosure.

As shown in FIGS. 7 and 8, the joint structure of a vehicle body for a vehicle according to the embodiment of the present disclosure may further include a lower chassis (SKB; skateboard) 80 coupled to the lower part of the underbody 100.

The lower chassis 80 may be fastened to the lower end of the fixing rail 10 and a lower end of the side sill 30. The lower chassis 80 may extend toward the front and rear of the cabin part 300 on a lower part side of the side member 50. Additionally, the lower chassis 80 may be arranged to be spaced apart from the side member 50 by a predetermined distance. An extended portion of the lower chassis 80 may be bent toward the lower part side of the side member 50.

The lower chassis 80 may serve to absorb external impact together with the side member 50 and the fender extension 70. A ‘C’ portion is a deformation section in which when the external impact is applied, the lower chassis 80, the side member 50, and the fender extension 70 may be deformed or fractured by absorbing the impact.

In addition, a battery is accommodated in the ‘F’ section, and the fixing rail 10, the side sill 30, and the lower chassis 80 are coupled in the ‘E’ section. In particular, the F and E sections are configured to form a ‘D’ section that is a rigid body section, in which when the external impact is applied, the shape is maintained without being damaged, and the robustness can be maintained by absorbing the impact.

As such, according to the joint structure of a vehicle body according to an embodiment of the present disclosure, it is possible to guide a path along which the upper body of the cabin part of the PBV can move up and down with respect to the upper part of the underbody. In addition, the upper body can disperse the load applied to the underbody to realize a stable vehicle body fastening structure, maintain vehicle body rigidity, and improve durability.

In addition, when impact from the outside is applied to the cabin part, since the fender member whose deformation is induced is adopted and a space is formed, the impact energy can be dispersed and absorbed, thereby improving safety during driving of a vehicle.

While this present disclosure has been described in connection with what is presently considered to be practical embodiments, it should be understood that the present disclosure is not limited to the disclosed embodiments. On the contrary, it is intended to cover various modifications and equivalent arrangements included within the spirit and scope of the appended claims.

### DESCRIPTION OF SYMBOLS

100: underbody
200: upper body
300: cabin part
10: fixing rail
11: first rail
12: bracket
13: second rail
14: fastening pin
15: opening
16: opening cover
20: fender apron
30: side sill
40: actuator
50: side member
60: pillar extension
70: fender extension
80: lower chassis (SKB; skateboard)

What is claimed is:

1. A joint structure of a vehicle body constituting a cabin part of a vehicle, the joint structure comprising:
an underbody forming a lower part of the cabin part;
an upper body coupled to an upper part of the underbody;
a fixing rail connecting the underbody and the upper body to each other, fixed to the underbody, and configured to guide the upper body when the upper body moves up and down relative to the underbody;
a fender apron provided at an upper edge portion of the underbody;
a side sill provided at a lower end edge portion of the underbody and coupled to a driving part;
an actuator provided on the side sill and installed at a lower end of the fixing rail and configured to provide a driving force so that the fixing rail moves up and down;
a side member coupled to front and rear ends of a central portion of the underbody; and
a fender extension connecting a lower part of the fender apron and an upper part of the side member.

2. The joint structure of claim 1, wherein the fixing rail comprises:
a first rail fixed to a body part of the underbody, and,
a second rail connected to the actuator at a lower end, inserted into the first rail and configured to move up and down within the first rail by the driving force of the actuator.

3. The joint structure of claim 2, wherein the second rail is inserted into a pillar of the upper body.

4. The joint structure of claim 1, further comprising a pillar extension connecting the lower part of the fender apron and the fixing rail.

5. The joint structure of claim 1, wherein a lower exterior surface of the fixing rail and an exterior surface of the side sill are fastened by a bracket.

6. The joint structure of claim 5, wherein the bracket is coupled to an upper surface of the side sill using at least one fastening pin.

7. The joint structure of claim 5, wherein the actuator is configured to penetrate a central portion of the bracket and is attached to the exterior surface of the side sill.

8. The joint structure of claim 6, wherein the at least one fastening pin comprises a plurality of fastening pins, and fastening pins of the plurality of fastening pins are arranged side by side, two on each of both side portions of the actuator.

9. The joint structure of claim 8, wherein an opening is formed in the side sill of a vehicle body inner side portion where the fastening pins are located.

10. The joint structure of claim 9, wherein the opening is covered by an opening cover at the vehicle body inner side portion.

11. The joint structure of claim 1, wherein the fender extension has a cross-section varying in an upper-lower direction of the vehicle body.

12. The joint structure of claim 11, wherein the fender extension is configured to be bent or fractured at a thin portion having a small cross-section when impact is transmitted from the side member.

13. The joint structure of claim 1, wherein a drive module to which an in-wheel motor is applied, a lower chassis, or a rolling chassis is further provided at a lower part of the underbody.

14. The joint structure of claim 13, wherein the lower chassis is fastened to the lower end of the fixing rail and a lower end of the side sill.

15. The joint structure of claim 14, wherein the lower chassis is configured to extend toward a lower part side of the side member and is spaced apart from the side member.

16. The joint structure of claim 15, wherein an extended portion of the lower chassis is bent toward the lower part side of the side member.
